(19) United States
(12) Patent Application Publication
(10) Pub. No.: US 2020/0252211 A1
(43) Pub. Date: Aug. 6, 2020

(54) METHOD FOR GENERATING SECURE RANDOMNESS ON BLOCKCHAIN

(71) Applicant: Cobinhood Ltd., Taipei City (TW)

(72) Inventors: TAI-YUAN CHEN, Taipei City (TW); WEI-NING HUANG, Taipei City (TW); PO-CHUN KUO, Taipei City (TW); HAO CHUNG, Taipei City (TW)

(21) Appl. No.: 16/777,943

(22) Filed: Jan. 31, 2020

Related U.S. Application Data
(60) Provisional application No. 62/799,171, filed on Jan. 31, 2019.

(51) Int. Cl. H04L 9/08; H04L 9/32

(52) U.S. Cl. CPC H04L 9/0869; H04L 9/085; H04L 9/3255; H04L 2209/08; H04L 9/08; H04L 9/0894; H04L 9/3236

(57) ABSTRACT

A method for generating a random number is used for a plurality of blocks in a blockchain. The method comprises the steps of: selecting a committee comprising a subset of nodes from the blockchain; executing a distributed key generation to generate a share key and a public key at each of the nodes, wherein the public key further comprises a set of verification keys; broadcasting a share signature from each of the nodes; executing a threshold signature at each of the nodes when a new block is generated; and executing a random number which is a hash value of the threshold signature which is combined from a plurality of partial signature generated from the nodes.

### CROSS-REFERENCE TO RELATED APPLICATION

This patent application claims the benefit of U.S. Provisional Application No. 62/799,171 filed Jan. 31, 2019 and the disclosure is incorporated herein by reference in its entirety.

### BACKGROUND OF THE INVENTION

### 1. Field of the Invention

The invention relates to a method or a system for generating a random number for a plurality of blocks in a blockchain, and particularly, to a random number generator for generating a random number which is unpredictable, unbiased, unique and verifiable.

### 2. Description of Related Art

Randomness is indispensable for many applications, particularly in lottery, gambling, fintech, game system, ticketing system etc. Although there are many pseudorandom number generators (PRNG) provided by various softwares and hardwares in the market, they have some drawbacks. For example, some of them are predictable. One may find some pattern of the random numbers even though the numbers satisfy the statistical behavior of the true random number. Or, the outputs of some PRNG cannot be verified. Consequently, other users must trust the providers of the PRNG, which is unrealistic in many applications.

On the other hand, a blockchain is a distributed ledger that multiple users can have a consensus on the same ledger without trusting each other. It is challenging to generate a cryptographically secure random source on blockchain. Currently, developers must rely on some trusted third party for random input, such as the service provided by Oracalize, or rely on some specific construction, such as the hash of the following blocks.

Thus, there is a need for a novel method to generate a random source on blockchain, and the random source is unpredictable, unbiased, unique and verifiable. The application provides a method or a system for generating a random number for a plurality of blocks in a blockchain, each block in the blockchain has a random number.

### SUMMARY OF THE INVENTION

The present application provides a method for generating a random number for a plurality of blocks in a blockchain, comprising: selecting a committee comprising a subset of nodes from the blockchain; executing a distributed key generation to generate a share key and a public key at each of the nodes, wherein the public key further comprises a set of verification keys; broadcasting a share signature from each of the nodes; executing a threshold signature at each of the nodes when a new block is generated; and executing a random number which is a hash value of the threshold signature which is combined from a plurality of partial signature generated from the nodes.

In another embodiment, the share signature is given by taking the share key and a value h into a function sharesign(share key, h), where h is a hash value of the new block.

In another embodiment, the threshold signature is given by taking the value h, the public key and the share signature into a function Combine(h, public key, share signature).

In another embodiment, the step of executing the distributed key generation further comprises: providing a plurality of validators including an i-th validator, a j-th validator and a k-th validator; having each of the validators register an ID that is associated with each of the validators; and broadcasting an ID message from each of the validators.

In another embodiment, the step of executing the distributed key generation further comprises: generating a plurality of secret key shares (SK_{i,0}, SK_{i,1}, . . . , SK_{i,n}) of order t from the each of validators if the one of validator sees the number of the ID messages is more than 2t+1 and less than 3t+1, wherein the value t is a number of Byzantine Agreement, and the number of the plurality of secret key shares is the same as the number of the registered ID; sending each of the secret key shares to the corresponding validator via a secure channel (i.e. the SK_{i,j} is sent to the j-th validator from the i-th validator); and broadcasting a master public key (MPKᵢ=MPK_{i,0}, MPK_{i,1}, . . . , MPK_{i,t}) of order t associated with the secret key shares from each of the validators.

In another embodiment, the step of executing the distributed key generation further comprises: having each of validators calculate a public key share (PK_{0,i}, PK_{1,i}, . . . , PK_{n,i}) using the corresponding master public key; and broadcasting a complaint (i.e. if the i-th validator verifies the secret key share (SK_{j,i}) is not associated with the public key share of the j-th validator (PK_{j,i}), the i-th validator broadcasts a complaint of the j-th validator (CMP_{i,j})) from each of the validators if each of the validators verifies the secret key share is not associated with the public key share of another validator.

In another embodiment, the step of executing the distributed key generation further comprises: broadcasting a nack complaint of the j-th validator (NCMP_{i,j}) from the i-th validator if the i-th validator does not receive the secret key share (SKj,i); and broadcasting the secret key share (SK_{j,i}) from the j-th validator if the j-th validator sees the nack complaint of the i-th validator (NCMP_{i,j}).

In another embodiment, the step of executing the distributed key generation further comprises: broadcasting the secret key (SK_{j,i}) from the k-th validator if the k-th validator receive the secret key (SK_{j,i}) and the value i is not equal to the value k; having the k-th validator execute a verification that the secret key (SK_{j,i}) is associated with the public key share of the j-th validator (PK_{j,i}) if the k-th validator sees the secret key (SK_{j,i}) and the value i is not equal to the value k; and broadcasting a complaint of j (CMP_{k,j}) from the k-th validator if the verification fails; and broadcasting a nack complaint of the j-th validator (NCMP_{k,j}) from the k-th validator if the k-th validator sees the nack complaint of the j-th validator (NCMP_{i,j}), the value j is not equal to the value k, and the k-th validator does not receive the secret key (SK_{j,i}).

In another embodiment, the step of executing the distributed key generation further comprises: broadcasting a distributed key generation final (DKGFinal) message from each of the validators; marking the j-th validator as a disqualified validator if a number of the nack complaint are sent to the j-th validator is more than the value t; and marking the j-th validator as the disqualified validator if the existing complaint (CMPi,j) is sent to the j-th validator.

In another embodiment, the step of executing the distributed key generation further comprises: having each of the validators determine a combined secret key (CSK); having each of the validators sign the DKGFinal message and broadcast the partial signature (PSig); and having each of the validators determine a combined public key (CPK) of the j-th validator.

In another embodiment, the step of executing the distributed key generation further comprises: having the i-th validator verify the partial signature (PSig) with the combined public key (CPK) if the i-th validator is not the disqualified validator; collecting the valid partial signature (PSig), wherein the number of the valid partial signature (PSin) are more than t; recovering the threshold signature; and verifying the threshold signature to determine a group public key.

The present application further provides a distributed system executed in a blockchain comprising: a plurality of nodes; and a committee; wherein the plurality of nodes are configured to: select a subset of nodes from the blockchain as the committee; wherein the committee is configured to: execute a distributed key generation to generate a share key and a public key at each of the nodes in the committee; broadcast a share signature from each of the nodes in the committee; execute a threshold signature at each of the nodes in the committee when a new block is generated; and execute a random number which is a hash value of the threshold signature which is combined from a plurality of partial signature generated from the nodes in the committee.

### BRIEF DESCRIPTION OF THE DRAWINGS

In order to sufficiently understand the essence, advantages and the preferred embodiments of the present invention, the following detailed description will be more clearly understood by referring to the accompanying drawings.

FIG. 1 is a block diagram of a distributed system in which some exemplary embodiments of the disclosed subject matter may be implemented.

FIG. 2 is a flow diagram of a process in accordance with some exemplary embodiments of the disclosed subject matter.

FIG. 3 is a block diagram of a distributed system in which some exemplary embodiments of the disclosed subject matter may be implemented.

### DETAILED DESCRIPTION OF THE INVENTION

The following description shows the preferred embodiments of the present invention. The present invention is described below by referring to the embodiments and the figures. Thus, the present invention is not intended to be limited to the embodiments shown, but is to be accorded the principles disclosed herein. Furthermore, that various modifications or changes in light thereof will be suggested to persons skilled in the art and are to be included within the spirit and purview of this application and scope of the appended claims.

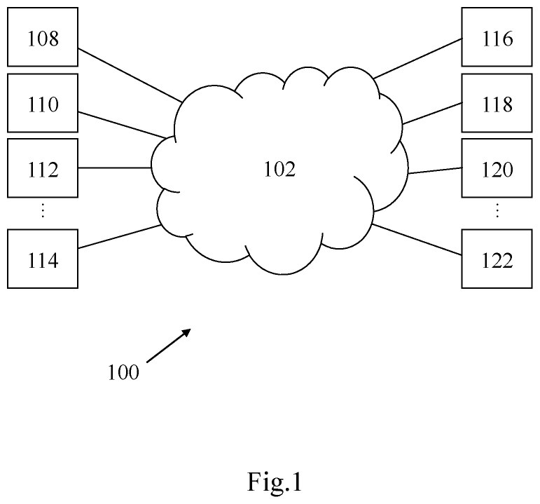

FIG. 1 is a diagram that shows a plurality of nodes 108-122 (e.g., individual personal computing devices, server computing devices, or other devices that have sufficient processor and storage abilities to participate in the system) connected to an internet 102 and connected to each other via the internet 102. The distributed system 100 in which transactions and records are organized in blocks includes the plurality of nodes 108-122. A committee is selected from the plurality of nodes 108-122 by using a Fisher-Yates shuffle algorithm with the previous block hash as the randomness. Let n be the number of nodes or parties within a committee and the number of adversaries within the committee be less than t. It is suggestable to set the threshold as ½+ϵ>t/n>⅓. A malicious parity can be controlled and perfectly coordinated by a single node, the adversary. The committee will run a distributed key generation (DKG) to generate a share key and a public key at each of the nodes in the committee for threshold signature, wherein the public key further comprises a set of verification keys. Then, each node in the committee broadcasts a share-signature on a confirmed block height h. After a block is generated, the committee signs a threshold signature on the block. Then, the hash of the threshold signature serves as the random number of the block. The committee is re-selected for each epoch. As will be understood by those skilled in the art, the present invention is applicable to all distributed computing environments and is not intended to be limited in any way by the exemplary distributed system of FIG. 1, which has been simplified for presentation purposes.

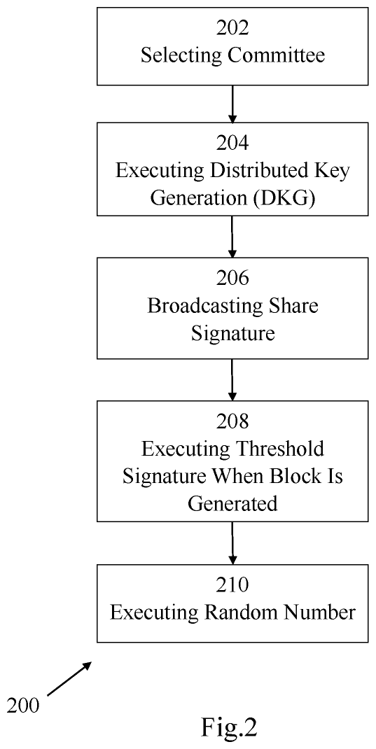

FIG. 2 is a flowchart diagramming a process 200, in accordance with some exemplary embodiments of the disclosed subject matter. Those skilled in the art will appreciate that the method illustrated by the flowchart of FIG. 2 is merely exemplary and that alternate variations may be employed, all in accordance with the present technique.

Process 200 begins with step 202, the committee is selected from the blockchain, and comprises a subset of nodes in the blockchain. In one exemplary embodiment, the committee may be selected from the plurality of nodes 108-122 by using a Fisher-Yates shuffle algorithm with the previous block hash as the randomness. In this embodiment, we need a committee of size n with the number of adversary less than t and a suggested setting for the threshold is ½+ϵ>t/n>⅓.

At Step 204, each of the nodes in the committee executes a distributed key generation of threshold signature to generate a share key and a public key, wherein the public key further comprises a set of verification keys. At next step 206, each of the nodes in the committee broadcasts a share signature that is formed by taking the share key and a value h into a function sharesign(share key, h) using a probabilistic polynomial-time algorithm or the like, where h is a height of the block (i.e., previous block).

At next step 208, when a new block is generated, the each node in the committee executes a threshold signature that is formed by taking the value h, the public key and the share signature into a function Combine(h, public key, share signature) using a probabilistic polynomial-time algorithm or the like.

At next step 210, each of the nodes in the committee executes a number for the block is a hash value of the threshold signature which is combined from a plurality of partial signature generated from the nodes in the committee, wherein the number is randomness for the new block.

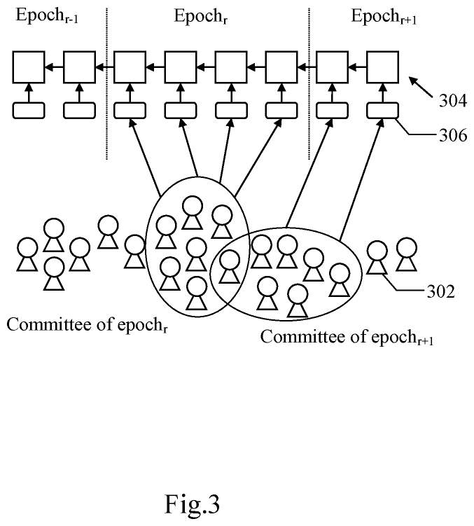

FIG. 3 is a diagram that shows a plurality of nodes 302. A committee is selected from some of the plurality of nodes 302. The committee is re-selected for each epoch. The committee can generate for an epoch for the blockchain. An epoch can be according to either a specific number of blocks or a fixed during of consensus time in the blockchain 304. The randomness 306 for blocks in an epoch may be generated by the same committee. The committee may compute the randomness into a function Hash(TSig(Block_hash)). The embodiment adopts an improved Verifiable Random Function (VRF) with Threshold Signature to generate the randomness for each block.

In another aspect, the overall procedure of Verifiable Random Function (VRF) with Threshold Signature protocol is summarized as below, that may provide better understanding of the present embodiment to those having ordinary skill in the art.

### Randomness Form VRF on Blockchain

1. KeyGen(1^{Δ}): each node i in committee executes KeyGen(1^{Δ}) of TSIG and get it own share-key SKᵢ, and the public key is ({VKᵢ}₌₁ⁿ,PK).
2. Prove(h,{SKᵢ}_{i∈S},{VKᵢ}ᵢ₌₁ⁿ,PK): each node i broadcasts its shared signature ρᵢ=ShareSign(SKᵢ, h) and executes TSign(h)=Combine(h, PK, {VKi}_{iϵS}, {ρi}_{iϵS}), where S is a subset of the committee and |S|=t. Then, the randomness for h is Hash(TSign(h)) and the proof π(h)=TSign(h).
3. Veri(PK, h, y, π): output

Verify−TSign(h,PK,π(h)))Λ(y₌^{?}Hash(π(h))).

In one exemplary embodiment, the distributed key generation comprises the following steps:

Step a) of ID Registration, at T<0: A plurality of validators registers comprising an i-th validator, a j-th validator and a k-th validator is provided. Each of the validators registers its ID(DKGMasterPublicKey); and each of the validators broadcasts an ID message (DKGMasterPublicKeyReady message). If the one of validator sees that the number of the ID messages is more than 2t+1, the process goes the next step.

Step b) of Secret Key Exchange, at T=0: The each of validators generates a plurality of secret key shares (SK_{i,0}, SK_{i,1}, . . . , SK_{i,n}) of order t, wherein the value t is a number of Byzantine Agreement, and the number of the plurality of secret key shares is the same as the number of the ID registrations. Each of the secret key shares is sent to the corresponding validator via a secure channel (i.e. the SK_{i, j} is sent to the j-th validator from the i-th validator). Each of the validators broadcasts a master public key (MPKᵢ=MPK_{i,0}, MPK_{i,1} . . . MPK_{i,t}) of order t associated the secret key shares.

Step c) of Complaint, at T=(0, λ): The each of validators calculates a public key share (PK_{0,i}, PK_{1,i}, . . . , PK_{n,i}) using the corresponding master public key, wherein the public key is define as: PK_{j,i}−F(MPK_{j,i}). If each of the validators verifies the secret key share is not associated with the public key share of another validator, the each of the validators broadcasts a complaint (i.e. if the i-th validator verifies the secret key share (SK_{j,i}) is not associated with the public key share of the j-th validator (PK_{j,i}), the i-th validator broadcasts a complaint of the j-th validator (CMP_{i,j})).

Step d) of Nack Complaint, at T=λ: If the i-th validator did not receive the secret key share (SK_{j,i}) the i-th validator broadcasts a nack complaint of the j-th validator (NCMP_{i,j}).

Step e) of Anti Nack Complaint, at T=2λ: If the j-th validator sees the nack complaint of the i-th validator (NCMP_{i,j}), the j-th validator broadcasts the secret key share (SK_{j,i}).

Step f) of Rebroadcast Secret, at T=3λ: If the k-th validator receives the secret key (SK_{j,i}) and the value i is not equal to the value k for the first time, the k-th validator broadcasts the secret key (SK_{j,i}).

Step g) of Enforce complaint, at T=4λ: If the k-th validator sees the secret key (SK_{j,i}) and the value i is not equal to the value k, the k-th validator executes a verification that the secret key (SK_{j,i}) is associated with the public key share of the j-th validator (PK_{j,i}); and if the verification fails, the k-th validator broadcasts a complaint of j (CMP_{k,j}); and if the k-th validator sees the nack complaint of the j-th validator (NCMP_{i,j}), the value j is not equal to the value k, and the k-th validator did not receive the secret key (SK_{j,i}) the k-th validator broadcasts a nack complaint of the j-th validator (NCMP_{k,j}).

Step h) of DKG Finalize, at T=5λ: Each of the validators broadcasts a distributed key generation final (DKGFinal) message.

Step i) of Sign with CSK, at T=6λ: Each of the validators waits until receiving more than 2t+1 final message. If a number of the nack complaint are sent to the j-th validator is more than the value t, the j-th validator is marked as a disqualified validator; and if the existing complaint (CMP_{i,j}) is sent to the j-th validator, the j-th validator is marked as the disqualified validator. Each of the validators determines a combined secret key (CSK); each of the validators signs the DKGFinal message with the CSK and broadcasts a partial signature (PSin); and each of the validators determines a combined public key (CPK) of the j-th validator.

Step j) of TSIG at T=(6λ, ∞): If the i-th validator is not the disqualified validator, the i-th validator verifies the partial signature (PSin) with the combined public key (CPK); the valid partial signature (PSin) is collected, and if the number of the valid partial signature (PSin) are more than t, the threshold signature is recovered.

Step k) of Verity TSIG Determines the group public key: The threshold signature is verified to determine a group public key.

In another aspect, the overall procedure of Distributed Key Generation protocol is summarized as below, that may provide better understanding of the present embodiment to those having ordinary skill in the art.

### Notations

λ: MAX (One gossip duration, transaction confirm latency)

Signature: BLS

Curve: CurveF p382-2

n: size of committee

t: number of Byzantine

### DKG and TSIG Protocol

Phase 1 ID Registration T<0:

Each validator registers its ID (DKGMasterPublicKeyᵢ) with stake. After each validator i broadcasts a DKGMasterPublicKeyReadyᵢ message. Validator waits until seeing more than 2t+1 DKGGroupPublicKeyReady message than proceeds to Phase 2.

Phase 2 Secret Key Share Exchange, T=0:

Each validator i generates n (n=# of ID registered in phase 1) secret key shares (SK_{i,0}, SK_{i,1}, . . . , SK_{i,n}) of order t and the secret key share is sent to the corresponding validator (SK_{i,j} is sent to validator j) via a secure channel. Each validator i broadcasts the master public key (MPKᵢ=MPK_{i,0}, MPK_{i,1}, . . . , MPK_{i,t}) of order t associated with the secret key shares.

Phase 3 Complaint T=(0, κ):

Each validator i calculates public key shares (PK_{0,i}, PK_{i,1}, . . . , PK_{n,i}) using corresponding master public key (PK_{j,i}=F(MPK_{j,i})). Each validator i verifies if the secret key share SK_{j,i} is associated with the public key share of validator j, PK_{j,i}. If the verification fails, i broadcast complaint of j, CMP_{i,j}.

Phase 4 Nack Complaint T=λ:

If validator i did not receive SK_{j,i}, broadcast nack complaint of j, NCMP_{i,j}.

Phase 5 Anti Nack Complaint T=2λ:

If validator j sees NCMP_{i,j} for any i, broadcast secret key share SKj,i.

Phase 6 Rebroadcast Secret T=3λ:

If validator k receive SK_{j,i} for the first time for i≠k, broadcast it again.

Phase 7 Enforce Complaint T=4λ:

If validator k sees SK_{j,i} for i≠k, verifies if the secret key share SK_{j,i} is associated with the public key share of validator j, PK_{j,i}. If the verification fails, k broadcast complaint of j, CMP_{k,j}. If validator k sees NCMP_{i,j} for j≠k and did not receive SK_{j,i}, k broadcast nack complaint of j, NCMP_{k,j}.

Phase 8 DKG Finalize T=5λ:

Each validator i broadcast a DKGFinal, message.

Phase 9 Sign with CSK T=6λ:

Validator waits until seeing more than 2t+1 final message. If there are more than t nack complaints to validator j ((i: for all validator i)), then j is marked as Disqualified. If there is one complaint, CMP_{i,j}, to validator j, then j is marked as Disqualified. Each validator i determines the combined secret key, (k: validator k is not marked as Disqualified). Each validator i sign the message with CSKᵢ and broadcast the partial signature, PSignᵢ. Each validator i determines the combined public key of validator j, (k: validator k is not marked as Disqualified).

Phase 10 TSIG T=(6λ, ∞):

If validator i is not Disqualified, verify PSignᵢ with CPKᵢ. Collect more than t valid PSignᵢ and recover TSIG.

Phase 11 Verify TSIG Determines the group public key, (k: validator k is not marked as Disqualified) Verify TSIG with GPK.

According to the present invention, the present application provides a method for generating a random number for a plurality of blocks in a blockchain. The random number provided by the application has unpredictable, unbiased, unique and verifiable characteristics.

By unpredictable, we mean that the random number should be indistinguishable from the string sampled from a uniform distribution when the transaction is sent (or the contract is deployed).

By unbiased, we mean that any single user cannot influence or change the random number even he or she deviates from the protocol arbitrarily (In our concrete construction, the number of users can be parametrized. Any portion of users below a pre-determined threshold cannot influence the random number. For example, the threshold can be ½. In this case, even half of the users collude, they still cannot bias). Without unbiasness, the block proposer may adjust the order of transactions to create a biased random number for his or her own profit. Thus, simply choosing the hash of the following blocks will not work.

By unique, we mean that there is only one random number can be generated given a specific block. Without uniqueness, the users may have multiple choices and may choose the best one for their own profit.

By verifiable, we mean that the authenticity of the random number can be verified by everyone, even the users who do not participate in the block generation.

Finally, the consensus of the random number is guaranteed by the blockchain, so every user can agree on the same random number of a given block. The random number is unpredictable, unbiased, unique and verifiable so that the random number is a secure randomness on the blockchain.

The foregoing embodiments of the invention have been presented for the purpose of illustration. Although the invention has been described by certain preceding examples, it is not to be construed as being limited by them. They are not intended to be exhaustive, or to limit the scope of the invention. Modifications, improvements and variations within the scope of the invention are possible in light of this disclosure.

What is claimed is:

1. A method for generating a random number for a plurality of blocks in a blockchain, comprising:
selecting a committee comprising a subset of nodes from the blockchain;
executing a distributed key generation to generate a share key and a public key at each of the nodes, wherein the public key further comprises a set of verification keys;
broadcasting a share signature from each of the nodes;
executing a threshold signature at each of the nodes when a new block is generated; and
executing a random number which is a hash value of the threshold signature which is combined from a plurality of partial signature generated from the nodes.

2. The method of claim 1, wherein the share signature is given by taking the share key and a value h into a function sharesign(share key, h), where h is a hash value of the block.

3. The method of claim 2, wherein threshold signature is given by taking the value h, the public key and the share signature into a function Combine(h, public key, share signature).

4. The method of claim 1, wherein the step of executing the distributed key generation further comprises:
providing a plurality of validators including an i-th validator, a j-th validator and a k-th validator;
having each of the validators register an ID that is associated with each of the validators; and
broadcasting an ID message from each of the validators.

5. The method of claim 4, wherein the step of executing the distributed key generation further comprises:
generating a plurality of secret key shares (SK_{i,0}, SK_{i,1}, . . . , SK_{i,n}) of order t from the each of validators if the one of validator see the number of the ID messages is more than 2t+1 and less than 3t+1, wherein the value t is a number of Byzantine Agreement, and the number of the plurality of secret key shares is the same as the number of the registered ID;
sending each of the secret key shares to the corresponding validator via a secure channel (i.e. the SK_{i,j} is sent to the j-th validator from the i-th validator); and
broadcasting a master public key (MPKᵢ=MPK_{i, 0}, MPK_{i, 1}, . . . , MPK_{i,t}) of order t associated with the secret key shares from each of the validators.

6. The method of claim 5, wherein the step of executing the distributed key generation further comprises:
having each of validators calculate a public key share (PK_{0,i}, PK_{1,i}, . . . , PK_{n,i}) using the corresponding master public key; and
broadcasting a complaint (i.e. if the i-th validator verifies the secret key share (SK_{j,i}) is not associated with the public key share of the j-th validator (PK_{j,i}) the i-th validator broadcasts a complaint of the j-th validator (CMP_{i,j})) from each of the validators if each of the validators verifies the secret key share is not associated with the public key share of another validator.

7. The method of claim 6, wherein the step of executing the distributed key generation further comprises:
broadcasting a nack complaint of the j-th validator (NCMP_{i,j}) from the i-th validator if the i-th validator does not receive the secret key share (SK_{j,i}); and
broadcasting the secret key share (SK_{j,i}) from the j-th validator if the j-th validator see the nack complaint of the i-th validator (NCMP_{i,j}).

8. The method of claim 7, wherein the step of executing the distributed key generation further comprises:
broadcasting the secret key (SK_{j,i}) from the k-th validator if the k-th validator receive the secret key (SK_{j,i}) and the value i is not equal to the value k;
having the k-th validator execute a verification that the secret key (SK_{j,i}) is associated with the public key share of the j-th validator (PK_{j,i}) if the k-th validator sees the secret key (SK_{j,i}) and the value i is not equal to the value k; and
broadcasting a complaint of j (CMP_{k,j}) from the k-th validator if the verification fails; and
broadcasting a nack complaint of the j-th validator (NCMP_{k,j}) from the k-th validator if the k-th validator sees the nack complaint of the j-th validator (NCMP_{i,j}), the value j is not equal to the value k, and the k-th validator does not receive the secret key (SK_{j,i}).

9. The method of claim 8, wherein the step of executing the distributed key generation further comprises:
broadcasting a distributed key generation final (DKGFinal) message from each of the validators;
marking the j-th validator as a disqualified validator if a number of the nack complaint are sent to the j-th validator is more than the value t; and
marking the j-th validator as the disqualified validator if the existing complaint (CMP_{i,j}) is sent to the j-th validator.

10. The method of claim 9, wherein the step of executing the distributed key generation further comprises:
having each of the validators determine a combined secret key (CSK);
having each of the validators sign the DKGFinal message and broadcast the partial signature (PSig); and
having each of the validators determine a combined public key (CPK) of the j-th validator.

11. The method of claim 10, wherein the step of executing the distributed key generation further comprises:
having the i-th validator verify the partial signature (PSig) with the combined public key (CPK) if the i-th validator is not the disqualified validator;
collecting the valid partial signature (PSig);
recovering the threshold signature, when the number of the valid partial signature (PSig) is more than the value t; and
verifying the threshold signature to determine a group public key.

12. A distributed system executed in a blockchain comprising:
a plurality of nodes; and
a committee;
wherein the plurality of nodes are configured to: select a subset of nodes from the blockchain as the committee;
wherein the committee is configured to: execute a distributed key generation to generate a share key and a public key at each of the nodes; broadcasting a share signature from each of the nodes in the committee; execute a threshold signature at each of the nodes in the committee when a new block is generated; and execute a random number which is a hash value of the threshold signature which is combined from a plurality of partial signature generated from the nodes in the committee.
